(19) United States
(12) Patent Application Publication
(10) Pub. No.: US 2012/0082791 A1
(43) Pub. Date: Apr. 5, 2012

(54) Coating Composition Amenable to Elastomeric Substrates

(76) Inventor: Robert Richard Liversage, Lebanon, OH (US)

(21) Appl. No.: 13/237,871

(22) Filed: Sep. 20, 2011

Related U.S. Application Data
(60) Provisional application No. 61/404,372, filed on Oct. 4, 2010.

(51) Int. Cl. C09D 109/08; C09D 115/00; C09D 109/10; B05D 1/32; C08K 3/34; C08K 5/098; B05D 1/28; B05D 1/02; C09D 113/02; C09D 107/02

(52) U.S. Cl. 427/282; 524/560; 524/558; 524/565; 524/563; 524/575; 524/571; 524/575.5; 524/27; 524/44; 524/35; 524/446; 524/450; 524/55; 524/399; 427/428.01; 427/429; 427/427.6

(57) ABSTRACT

Waterborne, polymer based coating compositions for interior and exterior use on elastomeric substrates (such as tires) with one or more polymer latex resins (having one or more carboxylic acid groups) in an amount sufficient to provide polymer solids in an amount of from 5 to 50% by weight of the coating; optionally one or more coalescing agents in an amount effective to coalesce and fuse polymer particles of the polymer latex resin into a relatively stretchable film when cured; one or more defoaming agents in an amount effective to enhance foam dissipation prior to film formation; one or more coupling agents having a first reactive group which is capable of bonding with the one or more carboxylic acid groups and a second reactive group which is capable of bonding with an elastomers substrate. Also, a method for applying such compositions to elastomeric substrates, such as tires.

### CROSS-REFERENCE TO RELATED APPLICATIONS

This application makes reference to and claims the benefit of the following co-pending U.S. Provisional Patent Application No. 61/404,372, filed Sep. 30, 2010. The entire disclosure and contents of the foregoing Provisional Application is hereby incorporated by reference.

### FIELD OF THE INVENTION

The present invention broadly relates to coating compositions for elastomeric substrates for use, for example, as decorative film-forming surface treatments for such elastomeric substrates, and more particularly as surface treatments for use on rubber tires.

### BACKGROUND

Conventional automotive tire shine products typically comprise silicone oil and petroleum distillates. Silicone oil is the main active ingredient. The final surface film comprises essentially silicone oil. Petroleum distillates are present in such products as a solvent-carrier for the purpose of altering the flow and leveling properties, as well as the viscosity, in order to achieve a smooth final film of uniform and desired thickness, to render the uncured composition easier to spread on the substrate surface, and to render the composition amenable to spray applications. Commercially available products are sold in piston-pump spray bottles, or in a pressurized canister (i.e., these products are applied to the substrate as a foam). Additionally, some products may also comprise polymers for the purpose of increasing longevity of films formed on the substrate surface.

### SUMMARY

According to a first broad aspect of the present invention, there is provided an composition comprising a liquid emulsion polymer coating which forms a solid film when cured, the coating comprising:

one or more polymer latex resins in an amount sufficient to provide polymer solids in an amount of from 5 to 50% by weight of the coating, the polymer latex resins having one or more carboxylic acid groups;

one or more defoaming agents in an amount effective to enhance foam dissipation prior to film formation;

one or more coupling agents having a first reactive group which is capable of bonding with the one or more carboxylic acid groups and having a second reactive group which is capable of bonding with an elastomers substrate, the coupling agents being in an amount sufficient for bonding the cured film to the elastomeric substrate; and

the balance water.

According to a second broad aspect of the present invention, there is provided a composition comprising a liquid emulsion polymer coating which forms a clear and colorless film when cured, the coating comprising:

one or more polymer latex resins in an amount sufficient to provide polymer solids in an amount of from 5 to 50% by weight of the coating, the polymer latex resins having one or more carboxylic acid groups;

one or more defoaming agents in an amount effective to enhance foam dissipation prior to film formation;

one or more coupling agents having a first reactive group which is capable of bonding with the one or more carboxylic acid groups and having a second reactive group which is capable of bonding with an elastomers substrate, the coupling agents being in an amount sufficient for bonding the cured film to an elastomeric substrate;

one or more rheology modifiers in an amount effective to enhance flow and leveling of the coating prior to curing; and

the balance water.

According to a third broad aspect of the present invention, there is provided a method for treating a surface of an elastomeric article. This method comprises the following steps:

(a) providing a composition comprising liquid emulsion polymer coating which forms a clear and colorless film when cured, the coating comprising:

one or more polymer latex resins in an amount sufficient to provide polymer solids in an amount of from 5 to 50% by weight of the coating, the polymer latex resins having one or more carboxylic acid groups;

one or more defoaming agents in an amount effective to enhance foam dissipation prior to film formation;

one or more coupling agents having a first reactive group which is capable of bonding with the one or more carboxylic acid groups and having a second reactive group which is capable of bonding with an elastomers substrate, the coupling agents being in an amount sufficient for bonding the cured film to the elastomeric substrate; and

the balance water; and

(b) treating a surface of an elastomeric article with the composition of step (a) to form a solid relatively stretchable film on the surface of the elastomeric article.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “elastomer” refers to all types of natural and synthetic rubbers, rubberoids, and polymeric materials that have the ability to undergo deformation under the influence of a force and then return to their approximate original shape and dimensions once the force has been removed. Such materials generally have a relatively low Young's modulus and high yield strain compared to other materials. Each of the monomers which link to form the polymer may be made of carbon, hydrogen, oxygen and/or silicon. Elastomers are amorphous polymers existing above their glass transition temperature, so that considerable segmental motion is possible. At ambient temperatures, rubbers may thus be relatively soft (E˜3MPa) and deformable.

For the purposes of the present invention, the term “latex,” in the context of coating compositions, refers to an aqueous dispersion of polymer latex resin. These dispersions may be prepared by emulsion polymerization. A latex may also comprise minor amounts of surfactant which serve to stabilize the polymer latex particles within the dispersion.

For the purposes of the present invention, the term “polymer latex resin” (which also may be referred to interchangeably as “binder”) refers to the solid constituent of the latex and which has one or more carboxylic acid groups. A partial list of starting monomers that may be used to produce polymer latex resins which may be used in embodiments of the present invention may include, but is not limited to, one or more of: methyl acrylate, methyl methacrylate, ethyl acrylate, propyl acrylate, butyl acrylate, propyl methacrylate, ethoxyethyl acrylate, methoxyethyl acrylate, methoxyethyl methacrylate, ethoxyethyl methacrylate, butyl methacrylate, isobutyl methacrylate, lauryl acrylate, stearyl acrylate, acrylic acid, methacrylic acid, butanedioc acid (succinic acid), adipic acid, ethylene acetate, propylene acetate, vinyl acetate, vinyl toluene, styrene, butadiene, isoprene, isobutylene, acrylonitrile, 2 ethyl hexyl acrylate, methacrylonitrile, etc. The amount of resin solids may comprise, for example, from about 5 to about 50% by weight, such as from about 10 to about 40% by weight of the composition.

For the purposes of the present invention, the term “acid number” refers to the conventional meaning of this term as measuring the amount of carboxylic acid groups present in the compound, polymer, etc. The acid number may be measured by titrating a known amount of sample compound dissolved in, for example, an organic solvent, with a solution of potassium hydroxide of known concentration using the following equation:

AN=(V_{eq}−b_{eq})N(56.6/W_{compound)}

Wherein AN is the acid number, V_{eq} is the amount of titrant (in ml) used (consumed), b_{eq} is the amount of titrant used (consumed) by a 1 ml spiking solution at the equivalent/equivalence point, 56.6 is the molecular weight of potassium hydroxide, N is the molarity (i.e., the molar concentration) of the titrant, and W_{compound} is the weight of sample compound being titrated. Acid number may be measured by ASTM D974-11 (Standard Test Method for Acid and Base Number by Color-Indicator Titration).

For the purposes of the present invention, the term “coupling agent” refers to any solvent or additive for enhancing adhesion (by, for example, forming chemical bonds) between the substrate and the films formed from embodiments of compositions of the present invention and which have a first reactive group which is capable of bonding with the one or more carboxylic acid groups of the polymer latex resin, and which also have a second reactive group which is capable of bonding with an elastomers substrate, the coupling agents being in an amount sufficient for bonding the cured film to the elastomeric substrate. Coupling agents act as a “chemical interface” between the substrate and the polymer latex resin of the film. Any solvent or additive (such as an “adhesion promoter,” “crosslinking,” “bonding agent,” etc.) which enhances bonding between the film formed by the polymer latex resin particles and the substrate may qualify as a coupling agent. In order for the cured film formed by the polymer latex resin to be bonded to the elastomeric substrate by the coupling agent, the acid number of the polymer latex resin may, for example, need to be at least about 10, for example, at least about 15. Coupling agents may include, but are not limited to, one or more of: acetoacetates, such as acetoacetanilide, ethyl acetoacetate, 1,1-dimethylethyl-3-oxobutanoate, etc.; amides, such as dicyandiamide, amidoamine, polyaminoamides, etc.; amines, such as benzoguanamine, diethyltoluenediamine, phenalkamine, hexamethoxymethylmelamine, melamine-formaldehyde, bis(triethoxysilylpropyl)amine, trimethylsilylpropylamine, N-ethyl-3-trimethoxysilyl-2-methylpropanamine, etc.; anhydrides, such as aliphatic polyanhydrides, 1,2,4,5-benzenetetracarboxylic dianhydride, etc.; aziridines, such as propylene immine, etc.; carbodiimides, such as dicyclohexylcarbodiimide, N,N′-diisopropylcarbodiimide,1-ethyl-3-(3-dimethylaminopropyl) carbodiimide, etc.; ureas, such as n-butoxymethyl methylol urea, N-(triethoxysilylpropyl)-urea-(3-ureidopropyltriethoxysilane), poly(urea-formaldehyde)s, etc.; phosphate esters, such as methyl phosphate, 2-ethylhexyl phosphate, poly(oxy-1,2-ethanediol)-hydro-hydroxy mono C₈ branched alkyl ether phosphates, poly(oxy-1,2-ethanediol)-hydro-hydroxy mono C₁₃ branched alkyl ether phosphates, poly(oxy-1,2-ethanediol)-phenyl-hydroxyphosphates, poly(oxy-1,2-ethanediol)-dinonylphenyl-hydroxyphosphates, etc.; organometallics, such as aluminates (such as, for example, aluminum diisopropoxy acetoacetic ester chelate), titanates (such as, for example, titanium IV 2, 2(bis 2-propenolatomethyl)butanolato tris(dioctyl)phosphato-O), and zirconates (such as, for example, zirconium IV 2, 2(bis-2-propenolatomethyl) butanolato tris(dioctyl)pyrophosphato-O), etc.; isocyanates, such as triphenylmethane-4,4′,4″-triisocyanate, isophorone diisocyanate, triisocyanates, tris(p-isocyanatophenyl) thiophosphate, 3-isocyanatepropyltrimethoxysilane, etc.; acrylates, such as dicyclopentadienyl acrylate, ethyldiglycol acrylate, lauryl acrylate, etc.; dimethylolpropionic acid, silanes, such as alkylsilanes, alkoxysilanes, alkylalkoxysilanes, amino silanes, benzyl amino silanes, chlorosilanes, chloropropylsilanes, diaminosilanes, ethoxysilanes, epoxy-functional-substituted-silanes, glycidoxypropylsilanes, mercaptosilanes, methacrylatesilanes, methoxysilanes, organosilane esters, organo-functional-silanes, sulfidosilanes, disulfidosilanes, tetrasulfidosilanes, ureidosilanes, vinylbenzylsilanes, vinylbenzylaminosilanes, etc., including: 3-acryloxypropyltrimethoxysilane, aminopropyltriethoxysilane, aminopropyltrimethoxysilane, aminoethylaminopropyltrimethoxysilane, aminoethylaminopropylsilane triol homopolymers, aminoethylaminopropylsilane, aminoethylaminopropylmethyldimethoxysilane, butyldimethylchlorosilane, chloropropyltrimethoxysilane, cyclohexylmethyldimethoxysilane, chloropropyltriethoxysilane, chloromethylsilyldimethylchlorosilane, dimethyldimethoxysilane, dimethyldichlorosilane, dimethylhydrogenchlorosilane, diisopropylyldimethoxysilane, diisobutyldimethoxysilane, dicyclopentyldimethoxysilane, beta-(3,4-epoxycyclohexypethyltrimethoxysilane, glycidoxypropyltrimethoxysilane, glycidoxypropyltriethoxysilane, glycidoxypropylmethyldimethoxysilane, 3-glycidoxypropylmethyldiethoxysilane, hexyltrimethoxysilane, bis(2-hydroxyethyl)-3-aminopropyltriethoxysilane, isobutyltrimethoxysilane, isobutyltriethoxysilane, isocyanatopropyltriethoxysilane, 3-isocyanatopropyltrimethoxysilane, isopropyltriethoxysilane, isopropyltrimethoxysilane, methyldimethoxysilane, methylchlorosilane, methyltrimethoxysilane, methyltriethoxysilane, mercaptopropyltrimethoxysilane, methacryloxypropyltriethoxysilane, octyltrimethoxysilane, octyltriethoxysilane, phenylsilanes, phenylalkoxysilanes, phenyltriethoxysilane, phenyltrimethoxysilane, propyltrimethoxysilane, propyltriethoxysilane, tetraethoxysilaneaminopropylsilanol, bis-triethoxysilylpropyldisulfidosilane, bis-triethoxysilylpropyltetrasulfidosilane, tetraethoxysilane, trimethylchlorosilane, bis(triethoxysilylpropyl)sulfidephenylaminopropyltrimethoxysilane, 3-triethoxysilyl-N-(1,3 dimethyl-butyliden), ureidopropyltrimethoxysilane, ureidopropyltrialkoxysilane, vinylbenzylaminoethylaminopropyltrihydroxysilane, vinyltriethoxysilane, vinylbenzylaminoethylaminopropyltrimethoxysilane, vinyltrimethoxysilane, vinylmethyldimethoxysilane, dimethyl siloxane-methyl hydrogen siloxane copolymers, etc. Epoxy-functional-substituted silanes may require a polymer latex resin with an acid number of, for example, at least about 10 in order to effectively bond the film formed by the polymer latex resin particles to the substrate. The amount of coupling agent may comprise, for example, from about 0.025 to about 10% by weight, such as from about 0.05 to about 5% by weight, based on the amount of polymer latex resin solids.

For the purposes of the present invention, the terms “wetting agent,” “surface active agent,” and “surfactant” (hereafter collectively referred to as “wetting agent”) refer interchangeably to any solvent or additive capable of lowering the surface tension of a liquid (i.e., the diluent), or the interfacial tension between a liquid and a solid. Wetting agents tend to migrate to and concentrate at liquid-solid and/or liquid-air interfaces. Wetting agents useful in embodiments of compositions of the present invention may also enhance leveling, defoaming, act as anti-tack and anti-block agents and/or emulsifiers, may also inhibit airborne particulate, dirt, soil, grease and oil, etc., adhesion to and/or absorption by the film, etc. Wetting agents also include detergents, emulsifiers, foaming agents, defoaming agents, and dispersants. Wetting agents may include, but are not limited to, one or more of: alcohols, such as POE-(7)-synthetic primary C₁₃-C₁₅ alcohol, the potassium salt of phosphated alcohols, ethoxyated alcohols, etc.; ethoxylates such as, nonylphenol ethoxylate, octylphenol ethoxylate, etc.; fluoro-substituted compounds, such as fluorinated acrylic copolymers, fluoroethoxylates, fluoroalcohols, fluorosilicones, fluoroglycols, fluoroalcohol glycols, tetrafluoroethylene copolymers, perfluoroalkylsulfonic acid, etc.; glycols, such as ethylene glycol, propylene glycol, diethylene glycol, etc.; glycol ethers, such as nonylphenol polyglycol ethers, polyethylene glycol ethers, propylene glycol normal butyl ether, etc.; glycol ether acetates, such as dipropylene glycol methyl ether acetate, propylene glycol methyl ether acetate, etc.; siloxanes (silicones), such as methylsiloxane, polysiloxanes, silicone polyether copolymers, silicone co-polymers, octamethylcyclotetrasiloxane, polydimethylsiloxanes, polyorgano siloxanes, silicone polyethers, silicone glycols, silicone polyalkyleneoxides, decamethylpentasiloxane, dimethylsiloxane, etc.; phosphate esters, such as polyether phosphate esters, alcohol ethoxylate phosphate esters, phosphated alcohols, etc.; polymers, such as polyethers, polyesters, polyalkylene glycols, polyamides, polyurethanes, propylene oxide copolymers, polyacrylates, alkyl copolymers, polyglucocides, ethylene oxide copolymers, polycarboxylic acids, etc.; surfactants, such as sodium dihexyl sulphosuccinate, dioctyl sulfosuccinate, alkyldiphenyloxide disulfonate, monoethanolamide, etc., terpenes such as, isoprene, limonene, terpineol, and squalene, etc.; waxes, such as partly saponified ester of montanic acids, vinyl acetate copolymers, non-ionic HDPE/carnauba wax, seed oil based wetting agents, etc. The amount of wetting agent may comprise, for example, from about 0.05 to about 5% by volume, such as from about 0.1 to about 3% by volume, e.g., from about 0.1 to about 2% by volume, of the composition.

For the purposes of the present invention, the term “anti-block agent” refers to any solvent or additive capable of minimizing dirt, soil, particulate, etc., adhesion on the film surface. Anti-block agents may cause the cured film to be less tacky. Anti-block agents may also lower the surface tension of a liquid, thereby enhancing the leveling and defoaming properties of embodiments of compositions of the present invention. Anti-block agents may tend to migrate to and concentrate at liquid-gas interfaces. Consequently, anti-block agents compatible with embodiments of compositions of the present invention may also inhibit oil, grease, solvent, etc., absorption by the film. A primary anti-block agent class of chemical compounds that is compatible with embodiments of compositions of the present invention is fluoro-substituted anti-block agents. Anti-block agents may include, but are not limited to, one or more of: fluoro-substituted compounds, such as fluoroalcohols, fluoroglycols, fluoroalcohol glycols, fluorosilicones, fluorinated acrylic copolymers, fluoroethoxylates, fluoroalkyl alcohol substituted polyethylenes, fluorinated substituted urethanes, perfluoroalkyl methacrylic copolymers, fluorinated substituted urethanes, perfluorohexylethyl alcohols, perfluoroalkyl polyurethanes, perfluorobutylethylenes, polyfluorosulfonic acids, perfluoroalkylsulfonic acids, perfluorohexylethyl methacrylates, etc.; metal oxides, such as nano-alumina particles, fumed alumina, fumed titanium dioxide, fumed zinc oxide, etc.; perfluoroalkanes, such as perfluorohexane, perfluorooctane, etc.; silicon-based compounds, such as synthetic amorphous silica, particulate silica, polysiloxanes (silicones), silicone-resins, silicone polyether copolymers, non-ionic HDPE/silicone wax, silicone polyether acrylates, silicone acrylates, etc.; telomer B phosphate ammonium salts, telomer B monoethers; wax-based compounds, such as polyethylene waxes, paraffin waxes, amide modified polypropylene waxes, amide waxes, polytetrafluoroethylenes, carnauba wax, etc. The amount of anti-block agent may comprise, for example, from about 0.005 to about 4.0% (by weight of the active ingredient), such as from about 0.01 to about 2.0% (by weight of the active ingredient), of the composition.

For the purposes of the present invention, the terms “coalescing agent,” “coalescing solvent,” and “organic solvent” (collectively referred to hereafter as “coalescing agent”) are used interchangeably to refer to any solvent or additive capable of enhancing the elastic properties (i.e., bend and stretch properties, which may be achieved by lowering the glass transition temperature (Tg)) of the final film. Coalescing agents may comprise coalescing agents having boiling points greater than about 100° C. As coalescing agents evaporate out of the film, they draw together and soften the polymer latex resin particles and fuse them together into irreversibly bound networked structures. Coalescing agents may also lower the minimum film forming temperature (MFFT) of the polymer latex resin, which in turn, promotes proper film formation at lower temperatures versus similar compositions that do not comprise coalescing agents. Coalescing agents may include, but are not limited to, one or more of: alcohols, such as amyl alcohol, n-butyl alcohol, isobutyl alcohol, cyclohexanol, diacetone alcohol, 2-ethylhexanol, furfural alcohol, methyl amyl alcohol, tridecylalcohol, tetrahydrofurfural alcohol, glycerine, etc.; acetates, such as amyl acetate, isobutyl acetate, n-butyl acetate, ethyl acetate, ethylhexyl acetate, n-propyl acetate, etc.; glycols, such as butoxytriglycol, butoxypolyglycols, 1-3 butylene glycol, diethylene glycol, ethylene glycol, ethoxytriglycol, ethoxypolyglycols, hexylene glycol, propylene glycol, triethylene glycol, tetraethylene glycol, tripropylene glycol, etc.; glycol ethers, such as diethylene glycol ethyl ether, diethylene glycol methyl ether, diethylene glycol monopropyl ether, diethylene glycol monohexyl ether, diethylene glycol monobutyl ether, diethylene glycol phenyl ether, dipropylene glycol n-butyl ether, dipropylene glycol n-propyl ether, dipropylene glycol methyl ether, dipropylene glycol ethyl ether, dipropylene glycol hexyl ether, dipropylene glycol phenyl ether, ethylene glycol phenyl ether, ethylene glycol 2-ethylhexyl ether, ethylene glycol monobutyl ether, ethylene glycol n-propyl ether, ethylene glycol monohexyl ether, ethylene glycol ethyl ether, ethylene glycol methyl ether, methylene glycol monoethyl ether, methylene glycol monopropyl ether, methylene glycol monobutyl ether, methylene glycol monohexyl ether, methylene glycol monophenyl ether, propylene glycol normal butyl ether, propylene glycol n-propyl ether, propylene glycol methyl ether, propylene glycol phenyl ether, propylene glycol ethyl ether, propylene glycol hexyl ether, tripropylene glycol n-butyl ether, tripropylene glycol methyl ether, etc.; glycol ether acetates, such as diethylene glycol ethyl ether acetate, diethylene glycol methyl ether acetate, diethylene glycol monopropyl ether acetate, diethylene glycol monohexyl ether acetate, diethylene glycol n-butyl ether acetate, diethylene glycol phenyl ether acetate, dipropylene glycol n-butyl ether acetate, dipropylene glycol n-propyl ether acetate, dipropylene glycol methyl ether acetate, dipropylene glycol ethyl ether acetate, dipropylene glycol hexyl ether acetate, dipropylene glycol phenyl ether acetate, ethylene glycol n-butyl ether acetate, ethylene glycol n-propyl ether acetate, ethylene glycol ethyl ether acetate, ethylene glycol hexyl ether acetate, ethylene glycol phenyl ether acetate, methylene glycol monophenyl ether acetate, methylene glycol hexyl ether acetate, methylene glycol monobutyl ether acetate, methylene glycol monopropyl ether acetate, methylene glycol ethyl ether acetate, propylene glycol methyl ether acetate, propylene glycol ethyl ether acetate, propylene glycol propyl ether acetate, propylene glycol butyl ether acetate, propylene glycol hexyl ether acetate, propylene glycol phenyl ether acetate, tripropylene glycol n-butyl ether acetate, tripropylene glycol methyl ether acetate, tripropylene glycol ethyl ether acetate, tripropylene glycol propyl ether acetate, tripropylene glycol hexyl ether acetate, tripropylene glycol phenyl ether acetate, etc; glycol acetates, such as ethylene glycol diacetate, propylene glycol diacetate, etc.; ethers, such as n-butyl ether, tributoxyethyl phosphate, etc.; ketones, such as diisobutyl ketone, isophorone, methyl isoamyl ketone, methyl isobutyl ketone, methyl n-propyl ketone, methyl n-amyl ketone, cyclohexanone, etc.; alcohol ethers, such as butoxy propoxy propanol, methoxy propoxy propanol, 1-methoxy-2-propanol, etc.; esters, such as dibasic ester, butyl propionate, ethyl 3 ethoxy propionate, isobutyl isobutyrate, glycerol esters, phenyl esters, phosphate esters, etc., phthalate esters such as, di-2-ethylhexylphthalate, diisononylphthalate, diisodecylphthalate, benzylbutylphthalate, alkyl benzyl phthalates, etc., ester alcohols such as, 2,2,4-trimethyl-1,3-pentanediol monoisobutyrate, 2,2,4-trimethyl-1,3-pentanediol mono(2-methylpropanoate), 2,2-dimethyl-1-(methylethyl)-1,3 -propanediol bis(2-methylpropanoate), 2,2,4-trimethyl-1,3-pentanediol 1-isobutyrate benzyl phthalate, etc., furfural; 2-nitropropane based coalescing agents; etc. The amount of coalescing agent may comprise, for example, from about 0.5 to about 50% by weight, such as from about 1 to about 30% by weight, based on the amount of polymer latex resin solids.

For the purposes of the present invention, the term “dispersing agent” refers to any solvent or additive capable of promoting even and homogenous dispersion of tint, hiding agent and/or extender pigment throughout the composition so that an even and consistent amount of color and opacity is observed throughout the final film. Suitable nonionic, cationic and anionic dispersing agents are commercially available. Dispersing agents may include, but are not limited to, one or more of: polymers, such as polyacrylates, polymethacrylic acid homopolymers, polyacrylic acids, polyamides, acidic polyester polyamides, polyamines, polyethers, alkyl ammonium salt copolymers, polycarboxylates, polyurethanes, alkyl poly glucosides, polyvinyls, polymeric esters, etc.; phosphate esters, such as potassium salt of phosphated aromatic ethoxylates, tristyrylphenol polyoxyethylene phosphoric acid esters, alkyl polyglycol ether phosphoric acid esters, potassium salt of phosphated alcohols, etc.; amino alcohols, such as 2-amino-2-methyl-1-propanol, 2-amino-2-ethyl-1,3-propanediol, etc.; ethoxylates such as, alkyl phenol ethoxylates, fatty alcohol ethoxylates, phosphated aromatic ethoxylates, etc.; soya lecithin; organomodified polysiloxanes; sodium salts of castor oil; polyoxyethylene sulphosuccinic acid esters; cellulosics; acethylene diols; modified fatty acids; naphthalene sulfonate formaldehyde condensates; styrene-maleinates; phenolic condensates, etc. The amount of dispersing agent may comprise, for example, from about 0.01 to about 10% by weight, such as from about 0.03 to about 5% by weight of the combined tint, hiding agent, and extender pigment solids content.

For the purposes of the present invention, the terms “rheology modifier, ” “flow and leveling agent,” and “thickening agent” (hereafter collectively referred to as “rheology modifier”) are used interchangeably to refer to any solvent or additive capable of altering (i.e., enhancing) the flow and leveling, sag and drip (i.e., minimizing sag and drip), viscosity, and application properties of a coating composition. Rheology modifiers may also enhance (i.e., increase) film thickness. Rheology modifiers may include, but are not limited to, one or more of: polymers, such as acrylics, urethanes, polycarboxylics, polysaccharides, polyethers, polyacetal polyethers, ethoxylated urethanes, olefinic copolymers, polyhydroxycarboxylic acid amides, polyamides, etc.; cellulose-types such as, hydroxyethyl methyl cellulose, ethyl cellulose, hydroxycellulose, ethyl hydroxyethyl cellulose, hydroxyethylcellulose, methylcellulose, hydroxypropyl methyl cellulose, etc.; organometallics, such as aluminates (such as, for example, aluminum octoate), zirconates (such as, for example, ammoniacal zirconium), titanates (such as, for example, titanium glycol alkanolamine complexes), etc.; carboxylic acids such as, cyclohexanedicarboxylic acid, 1,4-cyclohexanedicarboxylic acid, etc.; natural gums, such as hydrophobic treated natural gums, gar gum, xanthan gum, hydroxypropyl modified natural gums, etc.; organo-clays, such as calcium bentonite clay, methyl benzyl quaternary/bentonite clay, sodium bentonite clay, modified montmorrilonite clay, hectorite clay, attapulgite, magnesium aluminum silicate, organophilic smectite, etc.; organo-waxes; colloidal silica based rheology modifiers; etc. The amount of rheology modifier may comprise, for example, from about 0.1 to about 80% by weight, such as from about 0.4 to about 60% by weight, based on the amount of the polymer latex resin solids.

For the purposes of the present invention the term “sag and drip” refers to an excessive and undesirable amount of gravity-induced, post-application translational movement (e.g., displacement, migration, etc.), parallel to the plane of the substrate, on non-horizontal surfaces, that is substantial enough to promote the formation of unwanted film-surface-textures such as ripples and “tear-drop-shapes,” etc., prior to film formation, that remain in the final film. Sag and drip are a function of the rheological properties (e.g., viscosity, flow, leveling, etc.) of the composition. Some embodiments may be formulated to minimize sag and drip for the purpose of promoting the formation of smooth final films that are devoid of surface-textural properties. Excessive sag and drip may result in a portion of the composition applied migrating completely off the substrate.

For the purposes of the present invention, the terms “defoamer,” “defoaming agent,” and “antifoam,” (hereafter collectively referred to as “defoamer”) are used interchangeably to refer to any solvent or additive capable of suppressing foam formation and enhancing foam dissipation prior to film formation. Defoamers have an affinity for the air-liquid interface where they destabilize the foam lamellas. This causes rupture of the air bubbles and subsequent breakdown of surface foam. Defoamer agents may also lower the surface tension of a liquid, thereby also enhancing the leveling and wetting properties of the composition. A primary defoamer agent class of chemical compounds that is compatible with the present invention is siloxanes. Defoamers may include, but are not limited to, one or more of: polysiloxanes (silicones), such as dimethylsiloxane, decamethylpentasiloxane, organomodified silicones, octamethylcyclotetrasiloxane, silicone polyalkyleneoxides, silicone glycols, polydimethylsiloxanes, silicone co-polymers, polyether modified polysiloxanes, etc.; silicas, such as particulate silica, particulate silica emulsions, organo-silicas, etc.; ethoxylates, such as octylphenol ethoxylate, nonylphenol ethoxylate, alcohol ethoxylates, etc.; wax-based compounds, such as N,N′-bisstearoylethylendiamin, synthetic wax/mineral oil blends, etc.; fluoro-substituted compounds, such as fluorosilicones, fluorinated alcohols, fluoroalkyl alcohol substituted polyethylenes, fluorinated substituted urethanes, perfluoroalkyl methacrylic copolymers, perfluoroalkyl polyurethanes, perfluorobutylethylene, perfluorohexylethyl alcohols, perfluorohexane, perfluorooctane, perfluorohexylethyl methacrylate, polyfluorosulfonic acids, fluoroglycols, fluoroalcohol glycols, perfluoroalkyl methacrylate copolymers, perfluoroalkylsulfonic acid, fluorinated acrylic copolymers, fluoroethoxylates, etc.; polymers, such as polyethers, alkyl copolymers, alkyl polyglucocides, ethylene oxide copolymers, propylene oxide copolymers, polyalkyleneglycols, polyether polyols, phosphate polyether esters, polyethylene glycol copolymers, polypropylene glycol copolymers, polyacrylates, polypropylenes, etc., mineral oils, such as activated white oils, paraffin-based mineral oils, etc.; surfactant-type compounds, such as methacrylated mono- and di-phosphate esters, trialkyl phosphate esters, fatty acids, etc.; sulphur-based compounds, such as polyether sulfates, alkoxylate sulfates, dioctyl sulfosuccinate, alkyldiphenyloxide disulfonate, etc.; succinates; seed oil based defoamers; etc. The amount of defoamer agent may comprise, for example, from about 0.01 to about 4% by volume, such as from about 0.03 to about 2% by volume, of the composition.

For the purposes of the present invention, the terms “tint,” and “pigment,” (hereafter collectively referred to as “tint”) are used to refer to any solvent or additive capable of imparting color to films formed by the present invention. Pigments may be classified as either inorganic or organic types. Inorganic pigments typically utilize a metal oxide, insoluble metal salt or a natural mineral such as clays or micas as the color-forming component. Pigments may be used in combination in order to achieve the desired final appearance. The amount of pigment may comprise, for example, typically 50% or less by weight, based on the amount of the polymer latex resin solids.

For the purposes of the present invention, the terms “hiding pigment,” “hiding agent,” and “extender pigment” (hereafter collectively referred to as “hiding pigment”) are used interchangeably to refer to any additive capable of increasing the solids content (i.e., adding bulk to the film) and/or making the final film opaque. Hiding pigments may include, but are not limited to, one or more of: titanium dioxide, phthalo blue, red iron oxide, calcium carbonate, silica, diatomaceous earth, talc, clay, barium sulfate, etc. The amount of hiding agent may comprise, for example, about 50% or less by weight, based on the amount of polymer latex resin solids.

For the purposes of the present invention, the term “decorative particulate means” refers to a plurality of material types, colors, and shapes that may be embedded in uncured films of the present invention at the time of application for the purpose of enhancing the appearance of the film. An example is the shiny, plastic particulate material (roughly 1 mm² pieces of paper, glass or plastic painted in metallic, neon and iridescent colors to reflect light in a sparkling spectrum) referred to as “glitter”.

For the purposes of the present invention, the terms “solvent,” “diluent,” and “diluting solvent” (hereafter collectively referred to as “solvent”) are used interchangeably to refer to any solvent capable of diluting the polymer latex resin to achieve the desired physical properties of the final composition, including viscosity, flow, leveling, sag, drip, ease of application, final film thickness, cure rate, etc. The solvent is volatile and does not become part of the final film. Water may be used as the solvent in embodiments of compositions of the present invention. It is inert, cost-effective, non-toxic, non-flammable and environmentally friendly.

For the purposes of the present invention, the terms “anti-smudge,” “anti-streak,” “anti-mark,” and “anti-smear,” (hereafter collectively referred to as “anti-smudge”) are used interchangeably to define films formed by the present invention as being not easily removed by even strong abrasive interaction with a plurality of materials and items, including skin and clothing. Films formed by embodiments of compositions of the present invention may be dry, solid, non-greasy, etc. These films may not impart a streak, smear, smudge, stain, mark, or otherwise soil or make dirty, any object these films come in contact with.

For the purposes of the present invention, the terms “anti-splatter,” “anti-sag,” and “anti-drip,” (hereafter collectively referred to as “anti-splatter”) are used interchangeably to define embodiments of compositions of the present invention as curing to a dry film finish that is non-greasy, non-oily, and that has a non-fluid nature. Consequently, once cured, the films formed are incapable of dripping or sagging, and will also not splatter (i.e., these films will not be flung off the surface to which they are applied) when subjected to the rotational forces applied that are inherent of the intended use of the preferred objects to which the present invention is applied (i.e., automotive tires).

For the purposes of the present invention, the terms “anti-tack,” and “anti-dust,” (hereafter collectively referred to as “anti-tack”) are used interchangeably to infer that brake dust and various other types of small particulate materials (for example, about 5 mm or smaller with respect to the largest dimension) and objects do not become easily trapped, embedded or absorbed into the films formed by embodiments of compositions of the present invention, and also do not easily and readily adhere to the surface of these films.

For the purposes of the present invention, the term “rim guard” refers to a thin, flexible, for example, plastic, etc., capitol ‘T’-shaped partitioning tool used to prevent embodiments of compositions of the present invention from being unintentionally applied to, for example, wheel rims, etc., during application to, for example, tire surfaces, etc. The dimensions of the rim guard may be, for example, about five inches on the horizontal portion, about four inches on the vertical portion, about three-quarters of an inch in width on both horizontal and vertical portions, and about 0.02 inches thickness throughout. The top edge of the horizontal part of the ‘T’ may be inserted in the groove between the tire and the rim, at the section of the tire where embodiments of compositions of the present invention may be presently applied. The vertical portion of the ‘T’-shape may serve as a flexible handle which may be bent, as necessary, to allow for the rim guard to perform its intended function without obstructing the application of embodiments of compositions of the present invention on all sections of the sides of tires, from the tread-line to the tire/rim interface. The handle may allow the user to hold the rim guard in place, and displace the rim guard around the perimeter of the rim in the groove, as application of embodiments of compositions of the present invention progresses around the tire.

For the purposes of the present invention, the terms “applying,” “apply,” “applied,” or similar terms refer to any method, technique, etc., (including combinations of more than one such method, technique, etc.) of applying a material, coating, composition, etc., including treating, spreading, dabbing, daubing, spraying, brushing, rolling, wiping, etc.

For the purposes of the present invention, the term “solids content” refers to the weight percentage of each of the respective solid materials, compounds, substances, etc.(e.g., polymer latex resin) present in the composition. Unless otherwise specified, all percentages given herein for the solid materials, compounds, substances, etc., are on a solids basis.

For purposes of the present invention, all references to “by weight” refer to the weight amount of the particular active (e.g., polymer latex resin, coupling agent, wetting agent, anti-block agent, coalescing agent, dispersing agent, rheology modifier, defoamer, tint, hiding pigment, etc.) present in the composition, compound, component, ingredient, additive, solvent, diluent, etc.

For the purposes of the present invention, the term “liquid” refers to a non-gaseous fluid composition, compound, material, etc., which may be readily flowable at the temperature of use (e.g., room temperature) with little or no tendency to disperse and with a relatively high compressibility.

For the purposes of the present invention, the term “room temperature” refers to the commonly accepted meaning of room temperature, i.e., an ambient temperature of 20° to 25° C.

For the purposes of the present invention, the term “comprising” means various compositions, compounds, ingredients, components, elements, solvents, additives, diluents, capabilities and/or steps, etc., that can be conjointly employed in the present invention. Accordingly, the term “comprising” encompasses the more restrictive terms “consisting essentially of” and “consisting of.”

### DESCRIPTION

Embodiments of compositions of the present invention may comprise: a liquid emulsion polymer coating which forms a clear and colorless film when cured. The coating may comprise: one or more polymer latex resins (having one or more carboxylic acid groups) in an amount sufficient to provide polymer solids in an amount of from 5 to 50% by weight of the coating; optionally one or more defoaming agents in an amount effective to enhance foam dissipation prior to film formation; one or more coupling agents having a first reactive group which is capable of bonding with the one or more carboxylic acid groups and having a second reactive group which is capable of bonding with an elastomers substrate, the coupling agents being in an amount sufficient for bonding the cured film to an elastomeric substrate; and the balance water.

Embodiments of the liquid emulsion polymer coating of the compositions of the present invention may also comprise: one or more polymer latex resins (as defined above) in an amount sufficient to provide polymer solids in an amount of from 5 to 50% by weight of the coating; one or more coalescing agents in an amount effective to coalesce and fuse polymer particles of the polymer latex resin into a relatively stretchable film when cured; one or more defoaming agents in an amount effective to enhance foam dissipation prior to film formation; one or more coupling agents (as defined above) in an amount effective to bond (e.g., tenaciously bond) the resin to elastomeric substrates; one or more rheology modifiers in an amount effective to enhance flow and leveling, minimize sag and drip, etc., of the coating prior to curing; and the balance water.

Embodiments of the present invention may comprise a waterborne, acrylic-based coating composition. The uncured embodiments of these compositions may have flow and viscosity properties that are similar to that of a conventional latex paint. The final cured films from embodiments of compositions of the present invention may be either clear and colorless, or black and opaque, may comprise one or more (e.g., a plurality of) colors, etc. Additionally, some of these embodiments may form smooth and shiny final cured films.

Embodiments of compositions of the present invention may form final cured films that may be resilient, durable, hydrophobic, monolithic, UV resistant, may be more flexible and stretchable than a conventional acrylic latex film in the temperature range that is typical of the primary intended uses, may not be oily or slippery, etc. Embodiments of compositions of the present invention, whether cured or uncured, may be non-toxic, non-flammable, environmentally safe, etc. Due to their malleable nature, some embodiments of the cured compositions may not crack, chip, peel, blister, or yellow when employed for, and in the temperature range that is typical of, their primary intended uses (e.g., from about 0° to about 130° F.).

Embodiments of compositions of the present invention may provide a chemical formulation for the preparation of an aqueous liquid emulsion polymer coating composition. One use of such compositions is as a decorative dry-film-forming surface treatment for elastomeric substrates, and more particularly as a surface treatment for use on rubber tires. The uses of the embodiments of compositions of the present invention may be as a tire dressing on automotive rubber tires, as well as other types of rubber tires, etc. As such, some embodiments of compositions of the present invention may produce a black and shiny appearance on the tire surface. Other substrate types to which the embodiments of compositions of the present invention may be applied include, but are not limited to, for example, metal, metal oxide, glass, fiberglass, and ceramic substrates, including semi-conductor materials, etc. Some embodiments may contain minimal amounts of volatile organic compounds, may be non-toxic, and may be environmentally friendly. Cured films formed from embodiments of compositions of the present invention may be anti-smudge, anti-smear, anti-drip, anti-sag, anti-splatter, anti-tack, anti-dust, non-greasy, etc. These cured films may not readily trap dust or other forms of small airborne particulate. These cured films may tenaciously adhere (i.e., bond) to rubber and other elastomeric substrates. These cured films may not readily decouple, crack, chip, peel, blister, yellow, or otherwise come off, even when subjected to continuous, rapid deformational (i.e., distortional-type) forces, even in combination with daily and seasonal temperature variations. These cured films may not easily be leached, or decoupled, by moisture, rain, a high pressure stream of water, soap solutions, detergents, etc. These cured films may not be easily soiled by dirt, grease, oils (i.e., these types of materials do not readily adhere to the film surface or absorb into the film), etc. These cured films may form a dry-film-finish that will not evaporate under normal-use conditions, including direct sunlight on a hot summer day.

Films formed from embodiments of compositions of the present invention may be substantially more flexible and stretchable than conventional polymer latex compositions (e.g., commercial architectural paint products). Films formed by some embodiments may be clear and colorless, comprise tints and/or hiding agents, and may have a glossy, satin or matte finish. Some embodiments may also support particulate decorative means such as glitter when said decorative means are placed on the film surface prior to curing.

Some embodiments of compositions of the present invention may comprise both aqueous solvents and coalescing agents. Coalescing agents suitable herein may include, for example, 2, 2, 4-trimethyl-1, 3-pentanediol monoisobutyrate, etc. This solvent is clear, and colorless, and is not considered a hazardous material (HazMat) as defined by the Code of Federal Regulations (49 CFR). Other coalescing agents suitable herein may include, but are not limited to, one or more of: alcohols (e.g., amyl alcohol, isobutyl alcohol, cyclohexanol, etc.); alcohol ethers (e.g., butoxy propoxy propanol, methoxy propoxy propanol, 1-methoxy-2-propanol, etc.); acetates (e.g., isobutyl acetate, ethyl acetate, n-propyl acetate, etc.); ester alcohols (e.g., 2,2,4-trimethyl-1,3-pentanediol monoisobutyrate, 2,2,4-trimethyl-1,3-pentanediol mono(2-methylpropanoate), 2,2 -dimethyl-1-(methylethyl)-1,3-propanediol bis(2-methylpropanoate), etc.); esters (e.g., butyl propionate, glycerol esters, phosphate esters, etc.); ethers (e.g., n-butyl ether, tributoxyethyl phosphate, etc.); glycol ethers (e.g., diethylene glycol ethyl ether, dipropylene glycol ethyl ether, methylene glycol monobutyl ether, etc.); glycol acetates (e.g., ethylene glycol diacetate, propylene glycol diacetate, etc.); glycol ether acetates (e.g., diethylene glycol ethyl ether acetate, propylene glycol ethyl ether acetate, ethylene glycol ethyl ether acetate, etc.); glycols (e.g., diethylene glycol, ethylene glycol, propylene glycol, etc.); phthalate esters (e.g., di-2-ethylhexylphthalate, diisodecylphthalate, benzylbutylphthalate, etc.); ketones (e.g., methyl isobutyl ketone, methyl n-propyl ketone, cyclohexanone, etc.); etc., or mixtures thereof. The amount of coalescing agent may comprise, for example, from about 0.5 to about 50% by weight, such as from about 1 to about 30% by weight, based on the amount of polymer latex resin solids.

Embodiments of compositions of the present invention may be in the form of an environmentally and user-safe waterborne emulsion polymer coating. The one or more coalescing agents may perform one or more of four possible functions: These solvents may act as coupling agents between the aqueous phase and the water insoluble polymer molecules, promoting homogeneity between the two. As the composition cures, these solvents may act as coalescing agents, fusing the polymer particles into a smooth, clear, continuous film that is relatively more flexible and stretchable. In the absence of a coalescing agent, a similar composition cures to a relatively hard, brittle, and glass-like film. These solvents may increase the “open time” by slowing down the dissipation (evaporation) of water out of the uncured composition, after it is applied. This, in turn, facilitates the formation of a smoother final film by increasing the surface-leveling time. The one or more coalescing agents may also serve as wetting agents because they have a lower surface tension than water.

Water may serve as a diluting solvent. Water is cost-effective, non-toxic, non-hazardous, and chemically inert. However, other diluting solvents may also produce functionally similar compositions. Water may be added to lower the viscosity and increase the volume of the final composition in order to achieve the desired consistency with respect to spreadability during application, surface coverage, and final coating thickness.

For some embodiments of compositions of the present invention, the one or more aqueous liquid emulsion polymer resins may comprise, for example, one or more of: acrylic, urethane, carboxylic, or cellulose based resins (e.g., manufactured by Rohm and Haas under the trade name Rhoplex, such as, for example, Rhoplex VSR-50), etc., or mixtures thereof. These polymer emulsions are milky-white viscous liquids that may comprise approximately 50% water, and 50% polymer by weight. One or more surfactants may be present as minor constituents. The polymer molecules may be present in the form of colloidal-sized spherical particles that are coated with the surfactant. These emulsions may contain most of the polymer solids that form the final surface film. The various additives that also may be present in some embodiments of compositions of the present invention may contribute minor amounts of polymer. Only the various polymers, surfactants, and non-volatiles in the additives may remain in the final cured composition. The water content, coalescing agent, and the minor amounts of organic solvents that may be present in the one or more resins, and additives, may thus volatilize. However, trace amounts of coalescing agent/organic solvent may also remain.

Resins with relatively low glass transition temperatures (Tg), for example, less than about 15° C., may be advantageous because some of the intended uses of embodiments of compositions of the present invention may be as a tire dressing on automotive rubber tires, etc., as well as various other types of elastomeric substrates. Consequently, the final films formed by embodiments of compositions of the present invention may remain flexible and stretchable over a wide temperature range, including sub-freezing winter temperatures. The amount of polymer latex resin solids may comprise, for example, from about 5 to about 50% by weight, such as from about 10 to about 40% by weight, of the composition.

Additive types which may be present in some embodiments of compositions of the present invention include: defoamer, pigment, matting agent, hiding agent, dispersing agent, anti-block agent, wetting agent, coalescing agent, coupling agent, and rheology modifier. The emulsifiers in the polymer latex resins may promote bubble formation during application. If the bubbles do not dissipate, a smooth final film may not form. In order to minimize bubble formation during application, and enhance bubble dissipation before film formation, defoamer may be added to the system (e.g., composition). For embodiments of the present invention, the one or more defoamers may comprise, for example: silicon-based defoamers, such as siloxanes (e.g., sold by Dow Corning under the trade names #62 Additive, #71 Additive, #74 Additive, and #65 Additive), fluoro-substituted, or ethoxylate-based defoamers, etc., or mixtures thereof.

Some embodiments of the present invention may also comprise one or more rheology modifiers. Rheology modifiers may perform three main functions: (1) increase the viscosity of the composition, which in turn, minimizes sag and drip on non-horizontal substrates; (2) a thicker film may be easier to achieve with a more viscous composition; and (3) the addition of flow and leveling-type rheology modifiers may improve the flow characteristics of the composition during application, which, in turn, may enhance leveling of the uncured film, resulting in a smoother final finish. For some embodiments of the present invention, the one or more rheology modifiers may comprise, for example, polyurethane, acrylic, carboxylic, or cellulose type rheology modifiers (e.g., sold by Dow Corning under the trade name Acrysol RM, such as Acrysol RM 2020NPR and Acrysol RM 12W) etc., or mixtures thereof. For some embodiments of the present invention, the one or more wetting agents may comprise silicon-based, fluoro-substituted or ethoxylate-based wetting agents (e.g., sold by Dow Corning under the trade name #57 Additive, and sold by DuPont under the trade name Capstone, such as Capstone FS-30 and Capstone FS-61), etc., or mixtures thereof. Wetting agents may lower the surface tension of the solvent/diluent (for example, water), which may promote better adhesion between the resin and the substrate, and also serves to enhance leveling.

In order to promote better adhesion between the polymer resin and the substrate, one or more coupling agents may also be added to the system. Coupling agents act like a “chemical interface” between two relatively incompatible materials. Under static conditions, adhesion between the polymer films formed from embodiments of compositions of the present invention and rubber and other elastomeric substrates, in the absence of a coupling agent, may be sufficient for some applications. However, at 60 miles per hour, automobile tires may revolve approximately 600 times per minute. Consequently, the film and tire surface may be forced to bend and stretch 600 times per minute at these speeds, which facilitates separation (detachment, decoupling) of the polymer film from the tire surface. The addition of a coupling agent to embodiments of compositions of the present invention may very effectively overcome this problem. For some embodiments of the present invention, the one or more coupling agents may comprise, for example, silicon-based coupling agents, such as silanes (e.g., sold by Dow Corning under the trade name XIAMETER OFS-6040, and sold by GE Momentive under the trade names Silquest A-187, and CoatOSil MP 200), etc., or mixtures thereof.

In testing of tinted compositions, it may be observed that even with the addition of coupling agent, film integrity may be adversely affected by precipitation. A “wetted decoupling” phenomenon may effectively “knock” the film off the tire surface. A film that produces a black, shiny appearance under dry driving conditions may be totally removed under wet driving conditions. This problem may be resolved by the addition of one or more wetting agents, which enhance bonding between the coupling agent and the rubber substrate, by improving wetting of the uncured composition on the rubber substrate. For some embodiments of the present invention, the one or more wetting agents may comprise, for example, silicon-based wetting agents, such as siloxanes (e.g., sold by Dow Corning under the trade names #57 Additive and #67 Additive, and sold by GE Momentive under the trade name CoatOSil 1220), fluoro-substituted wetting agents (e.g. sold by DuPont under the trade name Capstone, such as Capstone FS-30), ethoxylate, and alkoxylate-based wetting agents, etc., or mixtures thereof.

One or more coalescing agents may be added to embodiments of the present invention to lower the Tg (i.e., glass transition temperature) of the final film. The Tg value obtainable when a reasonable amount of coalescing agent is added to the system may be substantially lower than the Tg value of the binder itself. Coalescing agents may have the added advantage of also lowering the minimum film forming temperature (MFFT), which is the lowest temperature at which the composition may be applied without compromising the aesthetics or structural integrity of the final, cured film. For some embodiments of the present invention, the one or more coalescing agents may comprise, for example, alcohol, alcohol ether, acetate, ester alcohol, glycol, glycol ether, glycol acetate, glycol ether acetate, ether, ester, phthalate ester, ketone-type coalescing agents (e.g., sold by Eastman Chemical Company under the trade name Texanol), etc., or mixtures thereof.

Tints may also be added to the system to give the final film color. Matting agents may also be added to produce a satin-to-matte final, cured film. Hiding agents may also be added for the purpose of making the final, cured film opaque. In the absence of tints, matting agents, and hiding agents, the final film may be clear, shiny, and colorless. For some embodiments of the present invention, the one or more hiding agents may comprise, for example, titanium dioxide type hiding agents (e.g., sold by DuPont under the trade name TiPure R706), etc., or mixtures thereof.

Other commercially available hiding agents may also be more compatible and suitable for use with the embodiments of the present invention, and may provide the desired level of opacity. For example, when titanium dioxide is added to the system, in the absence of tint, and matting agent, the final, cured film may be opaque white and shiny. When titanium dioxide and matting agent are added to the system, in the absence of tint, the final, cured film may be opaque white and satin-to-matte finish. For some embodiments of the present invention, the one or more tints may comprise, for example, products sold by Reitech Corp, such as the carbon black dispersion sold under the part number BK7NO32, etc., or mixtures thereof. For some embodiments of the present invention, the one or more matting agents may comprise, for example, silicon or wax based matting agents (e.g., sold by Michelman, Inc. under the trade name Michem), etc., or mixtures thereof.

One or more tint dispersing agents may also be added for the purpose of ensuring that both tint and the hiding agent disperse evenly in embodiments of compositions of the present invention so that an even and consistent amount of color and opacity is observed throughout the final film. For some embodiments of the present invention, the one or more tint dispersing agents may comprise, for example, polycarboxylate type dispersing agents (e.g., manufactured by Rohm and Haas under the trade name Tamol, such as Tamol 165A Dispersant and Tamol 731A Dispersant), etc., or mixtures thereof. However, it is anticipated that many of the commercially available tint dispersing agents may be compatible with embodiments of the present invention, and may also provide a level of dispersion consistent with an aesthetically pleasing final, cured film.

In addition to tire surfaces, some embodiments of the present invention may be applied to a variety of other substrates and objects as well, including but not limited to, for example, vinyl, leather, latex and oil-based paints, metal, metal oxide, ceramic, bare wood, stained or painted wood, lacquered or varnished wood, veneer, plastic, rubber, elastomeric materials, grout, caulking, concrete, brick, stone, stucco, fiberglass, glass, ceramic tile, drywall, etc.

Embodiments of the present invention may maintain integrity when applied to these substrates, and may not decouple from the substrate, on the recommended substrates at all temperatures ranging from below about 5° F., and in excess of about 150° F. Embodiments of this composition may maintain integrity when applied to substrates, and may also not decouple at even lower and higher temperatures than the range noted.

Other embodiments of the present invention may comprise other additives such as pigments (tints), hiding agents, dispersants, anti-blocking agents, fillers, adhesion promoters, crosslinking agents, accelerators, matting agents, surfactants, solvents, defoamers, rheology modifiers, preservatives, humectants, pH controllers, anti-freezes, coalescents, plasticizers, wetting agents, coupling agents, microbicides, etc.

Embodiments of the present invention may offer several advantages over silicone oil based tire dressings, such as:

(1) Greater durability. Whereas, silicone oil based products typically wear off within one week under normal use conditions, embodiments of the present invention may remain on the tire surface for several weeks, and even for several months.

(2) Not adversely affected by moisture, precipitation, soaps, detergents, a steady stream of water, or commercial car washes. Films formed by embodiments of the present invention may be cleaned using a soap-foaming brush followed by high pressure water rinse, subjected to several rain storms, etc., with minimal changes to the appearance. Silicone oil based products are essentially removed by even one moderate rain or even one car washing.

(3) Shinier film. While silicone oil based products do produce a finish on automotive tires that is noticeably shinier and blacker than an untreated surface, consumers may prefer the shiny black dry-film-finish provided by embodiments of the present invention over oil based finishes.

(4) Some embodiments of the present invention comprising tint and/or hiding agent may hide blemishes on the tire surface because the final film is opaque. Silicone oil based finishes may not.

(5) Embodiments of the present invention may be offered in a variety of colors, including metallic colors, if desired, may support decorative inclusions, such as glitter or sparkles, if desired, and may be offered in shiny, satin, or matte finish. Silicone oil based products may not provide these benefits.

(6) Conventional silicone oil based products may not be recommended on bikes and motor cycles because the oil will make the tread slippery and may cause the rider to slip and fall. Embodiments of the present invention may not be as slippery by forming a dry film. Consequently, embodiments of the present invention may be safer for use on these types of rubber tires.

(7) Silicone oil based tire dressing products may comprise petroleum distillates which are combustible. Some embodiments of the present invention may not contain any combustible materials.

(8) Petroleum distillates may be skin, lung and eye irritants. Embodiments of the present invention may not contain such irritants.

(9) Petroleum distillates may be volatile organic compounds, and harmful to the environment. Some embodiments of the present invention may qualify as a “green” composition, and thus environmentally-friendly. At most, there may be only trace amounts of volatile organic compounds in some of the additives, which may only be present in some embodiments of the present invention in minor amounts.

(10) Petroleum distillates may be relatively strong solvents, and may cause rubber substrates to denature, harden, and eventually crack with repeated application.

(11) Rubber substrates coated with embodiments of the present invention may be effectively sealed and isolated from the combined surface drying and hardening effects of UV radiation and oxygen/ozone exposure. Consequently, these sealed surfaces may be less likely to experience cracking over time.

(12) When applied to newer tires (for example, under 6,000 miles of use), products containing petroleum distillates may form a permanently staining discharge with the tint and/or additives in automotive tire rubber. Embodiments of the present invention may not leach additives or tint from automotive rubber.

(13) Petroleum distillates may damage paint finish and some plastics, if not removed quickly. Embodiments of the present invention may not contain any damaging solvents.

(14) Many commercial tire dressings are sold in spray bottle format. Overspray may get on the wheels or on the car body, causing damage to finishes that are susceptible to petroleum distillates. The suggested application techniques for embodiments of the present invention may be by using a small high density foam roller. Consequently, the potential for embodiments of the present invention to be accidently applied to surfaces other than the tires may be minimal

(15) Any excess silicone oil based product applied to tires that is not wiped off before the vehicle is used may be spun off the tire and on to other parts of the vehicle once the vehicle starts moving. Embodiments of the present invention form a dry film within approximately half an hour.

(16) The finish achieved by embodiments of the present invention may impart a shiny, black dry-film-finish to automotive and non-automotive tire substrates, etc.

(17) Embodiments of the present invention may be more cost-effective to use than silicone oil based products because significantly less material may be required to achieve proper coverage, and the finish may last substantially longer.

(18) Silicone oil based products may form a tacky film that readily traps dust (including brake pad dust). The resultant mixture may also form a black, greasy film that wipes off easily. Consequently, a clothing item or bare skin surface that rubs up against the tire surface may be easily soiled, and may not be easily cleaned. Embodiments of the present invention may form a non-greasy, non-tacky film that does not readily trap dust and may not be removed when a clothing item or bare skin surface comes in contact with it.

(19) Since films formed by silicone oil based products may tend to trap dust more readily than films formed by some embodiments of the present invention, these silicone oil based products may be more susceptible to luster-fade. Films formed by embodiments of the present invention may be more likely to remain shinier longer.

(20) Films formed by silicone oil based products may be susceptible to evaporation when exposed to direct sunlight. The polymer-based films formed by embodiments of the present invention may not be susceptible to evaporation.

(21) Silicone oil based products must be kept out of auto body repair shops because when trace amounts of oil vapors condense on a car surface that is to be painted, pinhead-sized craters referred to as “fish eye” may form on the paint film. Embodiments of the present invention may not comprise any chemical constituents that will cause fish eye.

For embodiments of compositions of the present invention, a method is also provided for treating a surface of an elastomeric article (e.g., an elastomeric substrate) with the composition to form a solid relatively stretchable film on the surface of the elastomeric article. In some embodiments of this method, an applicating tool, for example, a high density foam roller (manufactured by, for example, Work Tools International under the Trade name Whizz Roller System), etc., may be contacted with, loaded with, etc., embodiments of compositions of the present invention in an amount sufficient to apply, spread, etc., the composition on, for example, elastomeric substrates, etc., to form a smooth, continuous film without excessive rolling. Excessive rolling may prevent complete bubble dissipation and may result in a more textured final surface film. As the composition is transferred, displaced, etc., from the applicating tool to the substrate, the applicating tool becomes depleted of the composition of the present invention. The applicating tool may be, reloaded, replenished, etc., one or more times (e.g., periodically), with application, spreading, etc., on the substrate continued, until the desired amount of substrate surface area coverage has been achieved. Applying embodiments of compositions of the present invention to, for example, one smaller section of the substrate surface at a time, and gradually working around the entire surface, may also produce a more desirable result.

Embodiments of compositions of the present invention may be amenable to various other modes of application, including, but not limited to, for example, treating, spreading, dabbing, daubing, spraying, brushing, rolling, wiping, etc. In the case of spraying, suitable spray applicators may include, but are not limited to, for example, piston-pump, pressurized canister, compressed gas (for example, air, nitrogen, carbon dioxide, etc.) type applicators, etc. Various types of absorbent paper or cloth products may be used as wipe applicators. White paper and cloth applicators may be desirable because the dyes in colored articles may bleed, discolor, etc., the finish. Sponges may also be used. Wiping may only be desirable on surfaces that are not abrasive enough to compromise the structural integrity of the applicator. Otherwise, small particles of the applicator material may end up stuck to the surface of the elastomeric substrate. Conventional paintbrushes and paint rollers may also be used for brushing, rolling, wiping, etc., respectively.

A blacker and shinier finish may be obtained on newer and older tires by applying two or more coats of embodiments of compositions of the present invention. A more appealing final appearance may be obtained by applying two or more coats of embodiments of compositions of the present invention on other substrate-types as well. When applying two or more coats of embodiments of compositions of the present invention, it may be desirable, advantageous, etc., to allow the previous coats to dry completely (approximately from about 20 to about 45 minutes) before applying the next coat. Alternatively, successive coats may be applied, for example, one or more days apart. Applying the two or more coats one or more days apart may be advantageous because it may allow the previously applied coats to cure more completely. When applied to tires, if the vehicle is used between applications, it may be advantageous to perform a water-rinse of tire surfaces first, in order to remove any dust and dirt accumulation, as necessary, prior to application of the next coat. Tire surfaces may be allowed to dry completely after the water-rinse, before applying the next coat. Two or more thinner coats may produce a better result than one or more thicker coats.

To ensure proper adhesion and a smooth finish, the substrate may need to be clean, dry, free of, etc., for example, oils, waxes, silicone oil based finishes, grease, soap film, dust, dirt, etc., before applying embodiments of compositions of the present invention. Appropriate cleaning compositions, solvents, etc., may include, but are not limited to, for example, soap and water, alcohol, ammonia-based window cleaners, sodium metasilicate based tire cleaning products, etc., or combinations thereof. Any residue left by the cleaning product itself (for example, soap film, surfactants, etc.) may also be removed. A nicer and more durable finish may be obtained on older tires, on tires on which silicone oil type tire dressings have been previously applied, etc., by cleaning tire surfaces with, for example, a detergent solution and/or a sodium metasilicate-based tire cleaning product, and a stainless steel scouring pad, etc., prior to application of embodiments of compositions of the present invention. Two applications of the tire cleaning product with scrubbing, and a water rinse after each, may be required. Substrate-cleaning techniques may include, for example, wiping substrates down with a wet cloth, paper towel or sponge, or a soft bristled brush and water, rinsing substrates with a hose or a pressure washer, or washing substrate surfaces with a mild detergent solution and then rinsing with water, etc. Substrate surfaces may be allowed to dry completely before applying embodiments of compositions of the present invention.

Detergents and tire cleaning products may contain surfactants in an amount sufficient to interfere with proper adhesion of embodiments of compositions of the present invention if not completely removed from the substrate prior to application. A pressure washer, high-pressure garden hose, or thorough wipe-down with a soft bristled brush and water, or wet cloth, sponge, or paper towel, etc., may be used to remove any surfactants left by detergents and cleaning products. If small (i.e. “pin-hole” sized) “craters” (also referred to as “fish eye”) form on films while applying embodiments of compositions of the present invention, this may indicate that there are still residual surfactants present on the substrate surface. Embodiments of compositions of the present invention may be removed before or after curing by scrubbing with, for example, a stainless steel or nylon scrub pad and water or mild detergent solution, etc., and then an additional, thorough, water-only rinse may be performed on the entire substrate surface to remove the residual surfactants. The surfactant-free substrate may be allowed to dry completely before resuming further application of embodiments of compositions of the present invention.

When outside temperatures exceed approximately 65° F., a desirable result may not be obtained if embodiments of compositions of the present invention are applied under direct sunlight. Also, a desirable result may not be obtained if embodiments of compositions of the present invention are applied to surfaces that are still warm (for example, above 90° F.). These conditions may accelerate the curing process, which may result in tiny ‘bubble-spots’ remaining on the film and may also result in the formation of a more textured film. Film integrity may also be compromised. However, any bubble-spots that form may become less noticeable, and the film-surface-texture may become smoother, after a few days. Better results may be obtained by applying embodiments of compositions of the present invention in an enclosed area, such as, for example, a garage, work shop, basement, etc., and in a temperature range of between, for example, about 40° F. and about 85° F. If embodiments of compositions of the present invention are applied at temperatures below 40° F., a proper film may not form and the finish may be hazy. When the air and/or substrate temperature is at or near the minimum recommended application temperature (e.g., about 40° F. or higher), it may be advantageous, appropriate, etc., to prepare a small test spot of embodiments of compositions of the present invention first on the surface to be coated, to ensure that a desirable finish may be attained.

When wiping embodiments of compositions of the present invention, it may be desirable to avoid employing a brisk scrubbing or buffing action, especially on smooth nonporous substrates, otherwise excessive foaming may occur which may not completely dissipate before curing. If the substrate is below, for example, about 85° F. during application, any foam that forms may effectively dissipate. However, it may be appropriate, advantageous, etc., to avoid applying embodiments of compositions of the present invention under direct sunlight when outside temperatures exceed approximately 65° F. Smoother strokes with a (thoroughly or properly) wetted applicator, may produce a more desirable result, e.g., loading the applicator, for example, a paper towel, etc., with embodiments of compositions of the present invention in an amount sufficient to thoroughly wet the applicator, and then applying the composition of the present invention to the substrate using smoother, slower strokes, may produce a more desirable result. If some bubbles do persist after curing, application of an additional coating using a (thoroughly or properly) wetted applicator, and a smoother application (motion or technique) may resolve the problem. For this same reason, cloth and absorbent paper applicators may perform better than sponges, which may also promote excessive foaming. Any residual foam “blemishes” may partially to fully dissipate by weathering over time.

Uses of embodiments of compositions of the present invention may include, but are not limited to, for example, as an attractive and durable, polymer-based rubber tire dressing that may be applied on all types of rubber tires used with vehicles, including but not limited to, for example, automobile tires, truck tires, bus tires, van tires, bicycle tires, motorcycle tires, golf cart tires, etc. Embodiments of compositions of the present invention may produce final films that are blacker and shinier than the rubber tires to which they are applied. The films formed may be smooth, and of a homogeneous appearance throughout.

If embodiments of compositions of the present invention that form clear and colorless films get on, for example, the wheels or the body of a car, etc., they may be wiped off with, for example, a damp paper towel, sponge, or cloth, etc. Alternatively, they may be left on such surfaces because they may not harm these surfaces. Once dry, some embodiments of the present invention that form clear and colorless films may not be noticeable on such surfaces, and they may eventually fall off because they have not been formulated to adhere to these types of surfaces. Unintentional application of embodiments of compositions of the present invention on wheels may be minimized by inserting, for example, a rim guard, etc., in the groove between the tire and the wheel at the section of the tire where embodiments of compositions of the present invention may be presently applied. A surface (e.g., rim) guard device (e.g., generally T-shaped with the top portion of the “T” being positioned against the rim proximate the tire surface for protection of the rim during application of the composition, and the bottom portion of the “T” being used to grip the rim guard) may also be employed as a partitioning tool when embodiments of compositions of the present invention are applied to other types of substrates as well, to protect other surfaces that are not meant to be treated (e.g., coated) with the composition.

Drying times for some embodiments of the present invention may be approximately, for example, from about 20 to about 45 minutes, depending upon the temperature, humidity, air circulation, etc., around the substrate. When applied to tires, films formed by embodiments of compositions of the present invention may be allowed to dry completely before using the vehicle (e.g., the milky appearance has totally disappeared). Exposing fresh coatings to rain, sustained wetting, etc., may cause the films to temporarily revert to the original milky appearance. Consequently, it may be advantageous to apply embodiments of compositions of the present invention on dry, low humidity days. Driving vehicles with fresh coatings applied to the tires under dry conditions and/or exposing the films to direct sunlight, after they have completely dried (e.g., the milky appearance has totally disappeared), may accelerate the final cure process.

If films formed by embodiments of compositions of the present invention become damaged (e.g. films are scuffed on a curb), the damaged portion may be prepared for reapplication, for example, with a damp non-scratch nylon dishwashing scrub pad, etc. The abrasive side of the scrub pad may be used to remove any loose flakes of the damaged portion of a film that may still be adhered to the surface. The surface may then be cleaned and allowed to dry, and embodiments of compositions of the present invention may be reapplied to the damaged portion.

Films formed by embodiments of compositions of the present invention may not blister, crack, chip, peel, or yellow at all temperatures between about 0° F. and about 150° F., when applied, for example, to any of the recommended substrates that have been properly cleaned and dried, as necessary, prior to application. Consequently, as an existing film weathers, as indicated by a loss of luster and/or color-fading, a fresh application of embodiments of compositions of the present invention may be applied directly over the clean and dry existing film. Additional surface preparation may not be required. Cured film integrity of embodiments of compositions of the present invention may also not be compromised at temperatures greater than or lower than the range cited above.

Embodiments of compositions of the present invention may also inhibit the drying-out, hardening, and cracking of elastomeric substrates to which they are applied. These degrading effects may be caused by a UV-induced (i.e. ultra-violet) reaction between the elastomeric (article or material) and oxygen and/or ozone. Slow evaporation of the one or more plasticizers that may be present in the elastomeric (article or material) may also promote drying-out, hardening, and cracking. Embodiments of compositions of the present invention may effectively protect the substrate from ultra-violet radiation, and may inhibit the one or more plasticizers that may be present from evaporating out of the substrate. Outdoor items that are exposed to direct sunlight may be more susceptible to hardening and cracking. Suggested applications may include, but are not limited to, for example, tires and various other elastomeric articles on automobiles, motor cycles, bicycles, trailers, farm equipment, homes, etc., including, for example, gaskets, seals, hoses, etc.

Existing films comprising embodiments of compositions of the present invention that have fully cured may be removed from, for example, a tire surface, etc., using, for example, a stainless steel or nylon scouring pad and water, or mild detergent solution, etc.

Embodiments of compositions of the present invention may be water soluble until cured, which may facilitate relatively quick and easy cleanup of spills, and all of the various types of applicators and receptacles that may be employed. Applicators and receptacles may be cleaned with water, or mild detergent solution followed by a water rinse. It may be advantageous to clean these items before the embodiments of compositions of the present invention dry. Embodiments of compositions of the present invention may be relatively safe to use, and when cured, may be non-flammable, non-combustible, and non-toxic. Films formed by embodiments of compositions of the present invention may not be oily and may be relatively non-slippery.

To maximize shelf life, containers of uncured embodiments of compositions of the present invention may be stored out of direct sunlight. To avoid irreversible damage to uncured embodiments of compositions of the present invention, they may not be allowed to freeze.

Embodiments of compositions of the present invention may comprise a relatively low volatile organic compounds (VOC's) content, and therefore may qualify as environmentally safe (i.e. “green”) compositions. Trace amounts of VOC's may be present as minor constituents in some of the additives which may only be present in minor amounts in embodiments of compositions of the present invention.

Embodiments of compositions of the present invention may be applied full strength; and thus not diluted. Fully cured films of embodiments of compositions of the present invention that have become soiled may be cleaned, for example, with a pressure washer, garden hose, damp cloth, damp paper towel, damp sponge, or a soft bristled brush and water, etc. Mild detergent solutions may also be used. Fully cured films of embodiments of compositions of the present invention may not be cleaned, subjected to, contacted with, etc., for example, abrasive cleaning products, mineral spirits, strong organic solvents, rubbing alcohol, etc. Hard water stains may be removed from films formed by embodiments of compositions of the present invention by wiping with vinegar on a cloth, sponge, or paper towel.

Other substrate-types that embodiments of compositions of the present invention may be used on include, but are not limited to, for example, vinyl, leather, latex and oil-based painted substrates, metal, metal oxide, ceramic, bare wood, stained or painted wood, lacquered or varnished wood, veneer, plastic, elastomeric materials, grout, caulking, concrete, brick, stone, stucco, fiberglass, glass, ceramic tile, drywall, etc.

### EXAMPLES

Illustrative examples of embodiments of compositions of the present invention are shown below:

### Example 1: Clear Coat Composition (with Anti-Tack Agent)

A clear coat composition that cures to a clear and colorless, shiny final film may be prepared from the following ingredients: between 5 and 50 percent by weight of resin solids (for example, Rhoplex VSR-50, available from Dow Corning); between 50 and 95 percent by weight of water; between 0.01 and 4 percent by volume of defoamer (for example, Dow Corning #74 Additive); between 0.005 and 4.0 percent by weight of anti-block agent (for example, Capstone FS-61, available from DuPont); between 0.5 and 50 percent by weight of coalescing solvent, based on the amount of polymer latex resin solids (for example, Texanol, available from Eastman Chemical Corp.); between 0.025 and 10 percent by weight of coupling agent, based on the amount of polymer latex resin solids (for example, XIAMETER OFS-6040, available from Dow Corning); and between 0.1 and 80 percent by weight of rheology modifier, based on the amount of polymer latex resin solids (for example, Acrysol RM 2020NPR and Acrysol RM 12W, available from Dow Corning). The clear coat composition may be applied to the tires using, for example, a high density foam roller (e.g., a Whizz Roller System) with a rim guard which may be generally T-shaped, with the top portion of the “T” being positioned against the rim for protection thereof during application of composition, and the bottom portion of the “T” being used to grip the rim guard.

### Example 2: Tinted Composition (with Anti-Tack Agent)

A tinted composition that cures to an opaque-black, and shiny final film may be prepared from the following ingredients: between 5 and 50 percent by weight of resin solids (for example, Rhoplex VSR-50, available from Dow Corning); between 50 and 95 percent by weight of water; between 0.01 and 4 percent by volume of defoamer (for example, Dow Corning #74 Additive); between 0.005 and 4.0 percent by weight of anti-block agent (for example, Capstone FS-61, available from DuPont); between 0.5 and 50 percent by weight of coalescing solvent, based on the amount of polymer latex resin solids (for example, Texanol, available from Eastman Chemical Corp.); between 0.025 and 10 percent by weight of coupling agent, based on the amount of polymer latex resin solids (for example, XIAMETER OFS-6040, available from Dow Corning); between 0.05 and 5 percent by volume of wetting agent (for example, Dow Corning #57 Additive); between 0.1 and 80 percent by weight of rheology modifier, based on the amount of polymer latex resin solids (for example, Acrysol RM 2020NPR and Acrysol RM 12W, available from Dow Corning); and between 0.1 and 15 percent by weight of tint (for example, Reitech Corporation carbon black dispersion, BK7NO32). The tinted composition may be applied to the tires using, for example, the high density foam roller with the rim guard as in Example 1.

### Example 3: Clear Coat Composition (without Anti-Tack Agent)

A clear coat composition that cures to a clear and colorless, shiny final film may be prepared from the following ingredients: between 5 and 50 percent by weight of resin solids (for example, Rhoplex VSR-50, available from Dow Corning); between 50 and 95 percent by weight of water; between 0.01 and 4 percent by volume of defoamer (for example, Dow Corning #74 Additive); between 0.5 and 50 percent by weight of coalescing solvent, based on the amount of polymer latex resin solids (for example, Texanol, available from Eastman Chemical Corp.); between 0.025 and 10 percent by weight of coupling agent, based on the amount of polymer latex resin solids (for example, XIAMETER OFS-6040, available from Dow Corning); and between 0.1 and 80 percent by weight of rheology modifier, based on the amount of polymer latex resin solids (for example, Acrysol RM 2020NPR and Acrysol RM 12W, available from Dow Corning). The clear coat composition may be applied to the tires using, for example, the high density foam roller with the rim guard as in Example 1.

### Example 4: Tinted Composition (without Anti-Tack Agent)

A tinted composition that cures to an opaque-black, and shiny final film may be prepared from the following ingredients: between 5 and 50 percent by weight of resin solids (for example, Rhoplex VSR-50, available from Dow Corning); between 50 and 95 percent by weight of water; between 0.01 and 4 percent by volume of defoamer (for example, Dow Corning #74 Additive); between 0.5 and 50 percent by weight of coalescing solvent, based on the amount of polymer latex resin solids (for example, Texanol, available from Eastman Chemical Corp.); between 0.025 and 10 percent by weight of coupling agent, based on the amount of polymer latex resin solids (for example, XIAMETER OFS-6040, available from Dow Corning); between 0.05 and 5 percent by volume of wetting agent (for example, Dow Corning #57 Additive); between 0.1 and 80 percent by weight of rheology modifier, based on the amount of polymer latex resin solids (for example, Acrysol RM 2020NPR and Acrysol RM 12W, available from Dow Corning); and between 0.1 and 15 percent by weight of tint (for example, Reitech Corporation carbon black dispersion, BK7NO32). The tinted composition may be applied to the tires using, for example, the high density foam roller with the rim guard as in Example 1.

### Example 5: Clear Coat Composition (without Coupling Agent)

A clear coat composition that cures to a clear and colorless, shiny final film may be prepared from the following ingredients: between 5 and 50 percent by weight of resin solids (for example, Rhoplex VSR-50, available from Dow Corning); between 50 and 95 percent by weight of water; between 0.01 and 4 percent by volume of defoamer (for example, Dow Corning #74 Additive); between 0.005 and 4.0 percent by weight of anti-block agent (for example, Capstone FS-61, available from DuPont); between 0.5 and 50 percent by weight of coalescing solvent, based on the amount of polymer latex resin solids (for example, Texanol, available from Eastman Chemical Corp.); and between 0.1 and 80 percent by weight of rheology modifier, based on the amount of polymer latex resin solids (for example, Acrysol RM 2020NPR and Acrysol RM 12W, available from Dow Corning). The clear coat composition may be applied to the tires using, for example, the high density foam roller with the rim guard as in Example 1.

### Example 6: Tinted Composition (without Coupling Agent)

A tinted composition that cures to an opaque-black, and shiny final film may be prepared from the following ingredients: between 5 and 50 percent by weight of resin solids (for example, Rhoplex VSR-50, available from Dow Corning); between 50 and 95 percent by weight of water; between 0.01 and 4 percent by volume of defoamer (for example, Dow Corning #74 Additive); between 0.005 and 4.0 percent by weight of anti-block agent (for example, Capstone FS-61, available from DuPont); between 0.5 and 50 percent by weight of coalescing solvent, based on the amount of polymer latex resin solids (for example, Texanol, available from Eastman Chemical Corp.); between 0.05 and 5 percent by volume of wetting agent (for example, Dow Corning #57 Additive); between 0.1 and 80 percent by weight of rheology modifier, based on the amount of polymer latex resin solids (for example, Acrysol RM 2020NPR and Acrysol RM 12W, available from Dow Corning); and between 0.1 and 15 percent by weight of tint (for example, Reitech Corporation carbon black dispersion, BK7NO32). The tinted composition may be applied to the tires using, for example, the high density foam roller with the rim guard as in Example 1.

All documents, patents, journal articles and other materials cited in the present application are hereby incorporated by reference.

Although the present invention has been fully described in conjunction with several embodiments thereof, it is to be understood that various changes and modifications may be apparent to those skilled in the art. Such changes and modifications are to be understood as included within the scope of the present invention as defined by the appended claims, unless they depart therefrom.

What is claimed is:

1. A composition comprising a liquid emulsion polymer coating which forms a solid film when cured, the coating comprising:
one or more polymer latex resins in an amount sufficient to provide polymer solids in an amount of from 5 to 50% by weight of the coating, the polymer latex resins having one or more carboxylic acid groups;
one or more defoaming agents in an amount effective to enhance foam dissipation prior to film formation;
one or more coupling agents having a first reactive group which is capable of bonding with the one or more carboxylic acid groups and having a second reactive group which is capable of bonding with an elastomers substrate, the coupling agents being in an amount sufficient for bonding the cured film to the elastomeric substrate; and
the balance water.

2. The composition of claim 1, wherein the polymer latex resin comprises one or more of the following monomers: methyl acrylate, methyl methacrylate, ethyl acrylate, propyl acrylate, butyl acrylate, propyl methacrylate, ethoxyethyl acrylate, methoxyethyl acrylate, methoxyethyl methacrylate, ethoxyethyl methacrylate, butyl methacrylate, isobutyl methacrylate, lauryl acrylate, stearyl acrylate, acrylic acid, methacrylic acid, butanedioc acid (succinic acid), adipic acid, ethylene acetate, propylene acetate, vinyl acetate, vinyl toluene, styrene, butadiene, isoprene, isobutylene, acrylonitrile, 2 ethyl hexyl acrylate, or methacrylonitrile.

3. The composition of claim 2, wherein the polymer latex resin comprises from about 10 to about 40% by weight of the composition and one or more of the following monomers:
acrylic acid; methacrylic acid; propyl acrylate; propyl methacrylate; methyl methacrylate;
methyl acrylate; butyl methacrylate; ethyl acrylate; butyl acrylate; or 2 ethyl hexyl acrylate.

4. The composition of claim 1, which further comprises one or more coalescing agents in an amount effective to coalesce and fuse polymer particles of the polymer latex resin into a relatively stretchable solid film when cured.

5. The composition of claim 4, wherein the one or more coalescing agents are selected from the group consisting of alcohols, alcohol ethers, acetates, ester alcohols, esters, ethers, glycol ethers, glycol acetates, glycol ether acetates, glycols, phthalate esters, and ketones and are in an amount of from about 0.5 to about 50% by weight, based on the amount of polymer latex resin solids.

6. The composition of claim 1, which further comprises one or more rheology modifiers in an amount effective to enhance flow and leveling of the coating prior to curing.

7. The composition of claim 6, wherein the one or more rheology modifiers are in an amount of from about 0.1 to about 80% by weight (based on the amount of polymer latex resin solids), and comprises one or more of the following rheology modifiers: acrylic polymers, urethane polymers, polycarboxylic polymers, polysaccharides, polyether polymers, polyacetal polyether polymers, ethoxylated urethane polymers, olefinic copolymers, polyhydroxycarboxylic acid amide polymers, polyamides, hydroxyethyl methyl cellulose, ethyl cellulose, hydroxycellulose, ethyl hydroxyethyl cellulose, hydroxyethylcellulose, methylcellulose, hydroxypropyl methyl cellulose, aluminum octoate, ammoniacal zirconium, titanium glycol alkanolamine complexes, cyclohexanedicarboxylic acid, 1,4-cyclohexanedicarboxylic acid, hydrophobic treated natural gums, gar gum, xanthan gum, hydroxypropyl modified natural gums, calcium bentonite clay, methyl benzyl quaternary/bentonite clay, sodium bentonite clay, modified montmorrilonite clay, hectorite clay, attapulgite, magnesium aluminum silicate, or organophilic smectite.

8. The composition of claim 7, wherein the one or more rheology modifiers are in an amount of from about 0.4 to about 60% by weight (based on the amount of polymer latex resin solids), and comprises one or more of the following rheology modifiers: acrylic polymers; urethane polymers; polycarboxylic polymers; polyether polymers;
polysaccharides; polyamides, hydroxyethyl methyl cellulose; ethyl cellulose;
hydroxycellulose; ethyl hydroxyethyl cellulose; hydroxyethylcellulose; methylcellulose; or hydroxypropyl methyl cellulose.

9. The composition of claim 1, wherein the one or more coupling agents are in an amount of from about 0.025 to about 10% by weight (based on the amount of polymer latex resin solids), and comprises one or more of the following coupling agents: acryloxypropyltrimethoxysilane; aminopropyltriethoxysilane; aminopropyltrimethoxysilane; aminoethylaminopropyltrimethoxysilane; aminoethylaminopropylsilane triol homopolymers; aminoethylaminopropylsilane; aminoethylaminopropylmethyldimethoxysilane; chloropropyltrimethoxysilane; chloropropyltriethoxysilane; beta-(3,4-epoxycyclohexypethyltrimethoxysilane; glycidoxypropyltrimethoxysilane; glycidoxypropyltriethoxysilane; glycidoxypropylmethyldimethoxysilane; glycidoxypropylmethyldiethoxysilane; 3-bis(2-hydroxyethyl)-3-aminopropyltriethoxysilane; methacryloxypropyltriethoxysilane; tetraethoxysilaneaminopropylsilanol; bis(triethoxysilylpropyl)sulfidephenylaminopropyltrimethoxysilane; vinylbenzylaminoethylaminopropyltrihydroxysilane; or vinylbenzylaminoethylaminopropyltrimethoxysilane.

10. The composition of claim 1, which further comprises one or more anti-tack agents in an amount effective to inhibit contaminants from adhering to or being absorbed by the cured films.

11. The composition of claim 1, which further comprises one or more pigments in an amount effective to add color to the coating.

12. The composition of claim 11, which further comprises one or more pigment dispersing agents in an amount effective to disperse the one or more pigments in the coating.

13. The composition of claim 11, which further comprises one or more wetting agents in an amount affective to lower the surface tension of the composition.

14. The composition of claim 1, which further comprises one or more decorative particulates.

15. The composition of claim 1, wherein the solid film formed is clear and colorless.

16. The composition of claim 1, wherein the polymer latex resin has an acid number at least about 10.

17. The composition of claim 16, wherein the polymer latex resin has an acid number at least about 15.

18. A composition comprising a liquid emulsion polymer coating which forms a clear and colorless film when cured, the coating comprising:
one or more polymer latex resins in an amount sufficient to provide polymer solids in an amount of from 5 to 50% by weight of the coating, the polymer latex resins having one or more carboxylic acid groups;
one or more defoaming agents in an amount effective to enhance foam dissipation prior to film formation;
one or more coupling agents having a first reactive group which is capable of bonding with the one or more carboxylic acid groups and having a second reactive group which is capable of bonding with an elastomers substrate, the coupling agents being in an amount sufficient for bonding the cured film to elastomeric substrates;
one or more rheology modifiers in an amount effective to enhance flow and leveling of the coating prior to curing; and
the balance water.

19. The composition of claim 18, which further comprises one or more coalescing agents in an amount effective to coalesce and fuse polymer particles of the polymer latex resin into a relatively stretchable solid film when cured.

20. The composition of claim 19, wherein the one or more coalescing agents are selected from the group consisting of alcohols, alcohol ethers, acetates, ester alcohols, esters, ethers, glycol ethers, glycol acetates, glycol ether acetates, glycols, phthalate esters, and ketones and are in an amount of from about 0.5 to about 50% by weight, based on the amount of polymer latex resin solids.

21. The composition of claim 18, which further comprises one or more anti-tack agents in an amount effective to prevent small particulate materials and objects from adhering to or being absorbed by the cured films.

22. The composition of claim 18, which further comprises one or more pigments in an amount effective to add color to the coating.

23. The composition of claim 22, which further comprises one or more pigment dispersing agents in an amount effective to disperse the one or more pigments in the coating.

24. The composition of claim 22, which further comprises one or more wetting agents in an amount effective to lower the surface tension of the composition.

25. The composition of claim 18, which further comprises one or more decorative particulates.

26. The composition of claim 18, which further comprises one or more rheology modifiers in an amount effective to enhance flow and leveling of the coating prior to curing.

27. The composition of claim 18, wherein the polymer latex resin has an acid number at least about 10.

28. The composition of claim 27, wherein the polymer latex resin has an acid number at least about 15.

29. The composition of claim 18, wherein the polymer latex resin comprises one or more of the following monomers: methyl acrylate, methyl methacrylate, ethyl acrylate, propyl acrylate, butyl acrylate, propyl methacrylate, ethoxyethyl acrylate, methoxyethyl acrylate, methoxyethyl methacrylate, ethoxyethyl methacrylate, butyl methacrylate, isobutyl methacrylate, lauryl acrylate, stearyl acrylate, acrylic acid, methacrylic acid, butanedioc acid (succinic acid), adipic acid, ethylene acetate, propylene acetate, vinyl acetate, vinyl toluene, styrene, butadiene, isoprene, isobutylene, acrylonitrile, 2 ethyl hexyl acrylate, or methacrylonitrile.

30. The composition of claim 29, wherein the polymer latex resin comprises from about 10 to about 40% by weight of the composition and one or more of the following monomers:
acrylic acid; methacrylic acid; propyl acrylate; propyl methacrylate; methyl methacrylate; methyl acrylate; butyl methacrylate; ethyl acrylate; butyl acrylate; or 2 ethyl hexyl acrylate.

31. The composition of claim 18, wherein the one or more rheology modifiers are in an amount of from about 0.1 to about 80% by weight (based on the amount of polymer latex resin solids), and comprises one or more of the following rheology modifiers: acrylic polymers, urethane polymers, polycarboxylic polymers, polysaccharides, polyether polymers, polyacetal polyether polymers, ethoxylated urethane polymers, olefinic copolymers, polyhydroxycarboxylic acid amide polymers, polyamides, hydroxyethyl methyl cellulose, ethyl cellulose, hydroxycellulose, ethyl hydroxyethyl cellulose, hydroxyethylcellulose, methylcellulose, hydroxypropyl methyl cellulose, aluminum octoate, ammoniacal zirconium, titanium glycol alkanolamine complexes, cyclohexanedicarboxylic acid, 1,4-cyclohexanedicarboxylic acid, hydrophobic treated natural gums, gar gum, xanthan gum, hydroxypropyl modified natural gums, calcium bentonite clay, methyl benzyl quaternary/bentonite clay, sodium bentonite clay, modified montmorrilonite clay, hectorite clay, attapulgite, magnesium aluminum silicate, or organophilic smectite.

32. The composition of claim 31, wherein the one or more rheology modifiers are in an amount of from about 0.4 to about 60% by weight (based on the amount of polymer latex resin solids), and comprises one or more of the following rheology modifiers: acrylic polymers; urethane polymers; polycarboxylic polymers; polyether polymers;
polysaccharides; polyamides, hydroxyethyl methyl cellulose; ethyl cellulose;
hydroxycellulose; ethyl hydroxyethyl cellulose; hydroxyethylcellulose; methylcellulose; or hydroxypropyl methyl cellulose.

33. The composition of claim 18, wherein the one or more coupling agents are in an amount of from about 0.025 to about 10% by weight (based on the amount of polymer latex resin solids), and comprises one or more of the following coupling agents:
acryloxypropyltrimethoxysilane; aminopropyltriethoxysilane; aminopropyltrimethoxysilane; aminoethylaminopropyltrimethoxysilane; aminoethylaminopropylsilane triol homopolymers; aminoethylaminopropylsilane; aminoethylaminopropylmethyldimethoxysilane; chloropropyltrimethoxysilane; chloropropyltriethoxysilane; beta-(3,4-epoxycyclohexypethyltrimethoxysilane; glycidoxypropyltrimethoxysilane; glycidoxypropyltriethoxysilane; glycidoxypropylmethyldimethoxysilane; glycidoxypropylmethyldiethoxysilane; 3-bis(2-hydroxyethyl)-3-aminopropyltriethoxysilane; methacryloxypropyltriethoxysilane; tetraethoxysilaneaminopropylsilanol; or bis(triethoxysilylpropyl)sulfidephenylaminopropyltrimethoxysilane.

34. A method comprising the following steps:
(a) providing a composition comprising liquid emulsion polymer coating which forms a clear and colorless film when cured, the coating comprising:
one or more polymer latex resins in an amount sufficient to provide polymer solids in an amount of from 5 to 50% by weight of the coating, the polymer latex resins having one or more carboxylic acid groups;
one or more defoaming agents in an amount effective to enhance foam dissipation prior to film formation;
one or more coupling agents having a first reactive group which is capable of bonding with the one or more carboxylic acid groups and having a second reactive group which is capable of bonding with an elastomers substrate, the coupling agents being in an amount sufficient for bonding the cured film to the elastomeric substrate; and
the balance water; and
(b) treating a surface of an elastomeric article with the composition of step (a) to form a solid relatively stretchable film on the surface of the elastomeric article.

35. The method of claim 34, wherein the elastomeric article of step (b) is a tire.

36. The method of claim 35, wherein the tire of step (b) is an automobile tire, a truck tire, a bus tire, a van tire, a bicycle tire, a motorcycle tire, or a golf cart tire.

37. The method of claim 34, wherein step (b) is carried out by applying the composition of step (a) to the surface of the elastomeric article with an applicating tool.

38. The method of claim 37, wherein the applicating tool of step (b) is one or more of the following: a foam roller, a paint brush, or a spray-type applicator.

39. The method of claim 37, wherein the applicating tool of step (b) is one or more of the following: white paper, a white cloth applicator, or a sponge.

40. The method of claim 34, wherein step (b) is carried out by applying the composition of step (a) to the surface of the elastomeric article by one or more of the following techniques: spraying, brushing, rolling, or wiping.

41. The method of claim 34, wherein step (b) is carried out by using a surface guard device to protect other surfaces which are not to be treated with the composition of step (a).

42. The method of claim 34, wherein the composition of step (a) further comprises one or more coalescing agents in an amount effective to coalesce and fuse polymer particles of the polymer latex resin into a relatively stretchable solid film when cured.

43. The method of claim 42, wherein the one or more coalescing agents of step (a) are selected from the group consisting of alcohols, alcohol ethers, acetates, ester alcohols, esters, ethers, glycol ethers, glycol acetates, glycol ether acetates, glycols, phthalate esters, and ketones.

44. The method of claim 34, wherein the polymer latex resin of step (a) comprises one or more of the following monomers: methyl acrylate, methyl methacrylate, ethyl acrylate, propyl acrylate, butyl acrylate, propyl methacrylate, ethoxyethyl acrylate, methoxyethyl acrylate, methoxyethyl methacrylate, ethoxyethyl methacrylate, butyl methacrylate, isobutyl methacrylate, lauryl acrylate, stearyl acrylate, acrylic acid, methacrylic acid, butanedioc acid (succinic acid), adipic acid, ethylene acetate, propylene acetate, vinyl acetate, vinyl toluene, styrene, butadiene, isoprene, isobutylene, acrylonitrile, 2 ethyl hexyl acrylate, or methacrylonitrile.

45. The method of claim 44, wherein the polymer latex resin of step (a) comprises from about 10 to about 40% by weight of the composition and one or more of the following monomers: acrylic acid; methacrylic acid; propyl acrylate; propyl methacrylate; methyl methacrylate; methyl acrylate; butyl methacrylate; ethyl acrylate; butyl acrylate; or 2 ethyl hexyl acrylate.

46. The method of claim 34, wherein the composition of step (a) further comprises one or more rheology modifiers in an amount effective to enhance flow and leveling of the coating prior to curing.

47. The method of claim 46, wherein the one or more rheology modifiers of step (a) are in an amount of from about 0.4 to about 60% by weight (based on the amount of polymer latex resin solids), and comprises one or more of the following rheology modifiers: acrylic polymers, urethane polymers, polycarboxylic polymers, polysaccharides, polyether polymers, polyacetal polyether polymers, ethoxylated urethane polymers, olefinic copolymers, polyhydroxycarboxylic acid amide polymers, polyamides, hydroxyethyl methyl cellulose, ethyl cellulose, hydroxycellulose, ethyl hydroxyethyl cellulose, hydroxyethylcellulose, methylcellulose, hydroxypropyl methyl cellulose, aluminum octoate, ammoniacal zirconium, titanium glycol alkanolamine complexes, cyclohexanedicarboxylic acid, 1,4-cyclohexanedicarboxylic acid, hydrophobic treated natural gums, gar gum, xanthan gum, hydroxypropyl modified natural gums, calcium bentonite clay, methyl benzyl quaternary/bentonite clay, sodium bentonite clay, modified montmorrilonite clay, hectorite clay, attapulgite, magnesium aluminum silicate, or organophilic smectite.
